(19) United States
(12) Patent Application Publication
(10) Pub. No.: US 2004/0161279 A1
(43) Pub. Date: Aug. 19, 2004

(54) APPARATUS FOR FORMING A FOLDING-LINE

(76) Inventor: Tzu-Feng Tseng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,043

(22) Filed: Feb. 4, 2004

Related U.S. Application Data
(63) Continuation-in-part of application No. 10/244,776, filed on Sep. 16, 2002.

(51) Int. Cl. B41J 11/26

(52) U.S. Cl. 400/621

(57) ABSTRACT

An apparatus for forming a folding-line on a material. The apparatus comprises a base for placing the material, a rail mounted on the base, a carriage slidably mounted on the rail, and a blade mounted on the carriage. The blade includes an arc-shaped portion for forming the folding-line on the material.

### CROSS REFERENCE TO RELATED APPLICATIONS

This is a continuation-in-part of application Ser. No. 10/244,776, filed Sep. 16, 2002, and which is included in its entirety herein by reference.

### BACKGROUND OF INVENTION

1. Field of the Invention

The present invention relates to an apparatus for forming a folding-line, and more particularly, to an office-applied apparatus for forming a folding-line.

2. Description of the Prior Art

For cutting paper, there are various trimming apparatuses. However, for forming a folding line on paper in order to fold the paper easily, there are few choices. Please refer to FIG. 1. FIG. 1 is a diagram of an apparatus 100 for forming a folding-line on a material according to the prior art. The apparatus 100 includes an upper body 110 and a lower body 120. The lower body 120 is V-shaped and its valley is marked 122. The upper body 110 includes a triangular part corresponding to the V-shaped lower body 120. When utilizing the apparatus 100 for forming a folding-line on a paper, the paper is put upon the lower body 120, and the place to be formed a folding-line thereon and the valley 122 are aligned. The upper body 110 approaches to the lower body 120 and leaves a folding-line on the paper put upon the lower body 120.

The apparatus 100 is an industrial equipment. The size of the apparatus 100 is huge and the operation of the apparatus 100 is heavy. Therefore the apparatus 100 is not suitable for office application.

### SUMMARY OF INVENTION

It is therefore a primary objective of the claimed invention to provide an apparatus for forming a folding-line on a material.

Briefly described, the claimed invention discloses an apparatus for forming a folding-line on a material. The apparatus comprises a base for placing the material, a rail mounted on the base, a carriage slidably mounted on the rail, and a blade mounted on the carriage. The blade includes an arc-shaped portion for forming the folding-line on the material.

It is an advantage of the present invention that utilization of the blade including an arc-shaped portion simplifies the task of forming a folding-line on a material. The blade forms a folding-line on the paper when rotating or sliding on the paper as the carriage slides along the rail. The structure of the apparatus is simple, the size of the apparatus is small, and the operation of the apparatus is easy. Therefore the claimed apparatus is suitable for office application.

These and other objectives of the present invention will no doubt become obvious to those of ordinary skill in the art after reading the following detailed description of the preferred embodiments that are illustrated in the various figures and drawings.

### BRIEF DESCRIPTION OF DRAWINGS

FIG. 1 is a diagram of a prior art apparatus for forming a folding-line on a material.

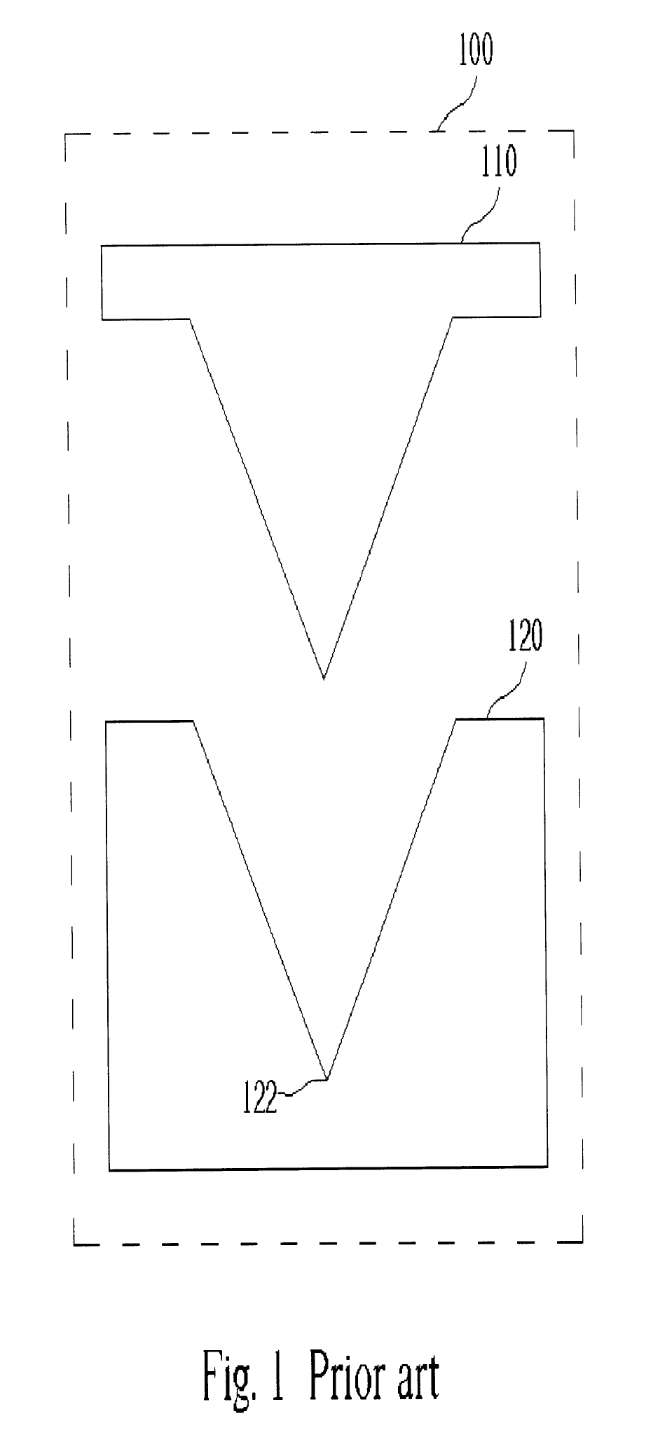

FIG. 2 is a diagram of a present invention apparatus for forming a folding-line on a material.

FIG. 3 is a diagram of the carriage and the blade in FIG. 2.

FIG. 4 is a side elevation of the carriage and the blade in FIG. 3.

FIG. 5 is a diagram of an embodiment of a carriage and a blade according to the present invention.

FIG. 6 is a side elevation of the carriage and the blade in FIG. 5.

FIG. 7 is a side elevation of a blade according to the present invention.

### DETAILED DESCRIPTION

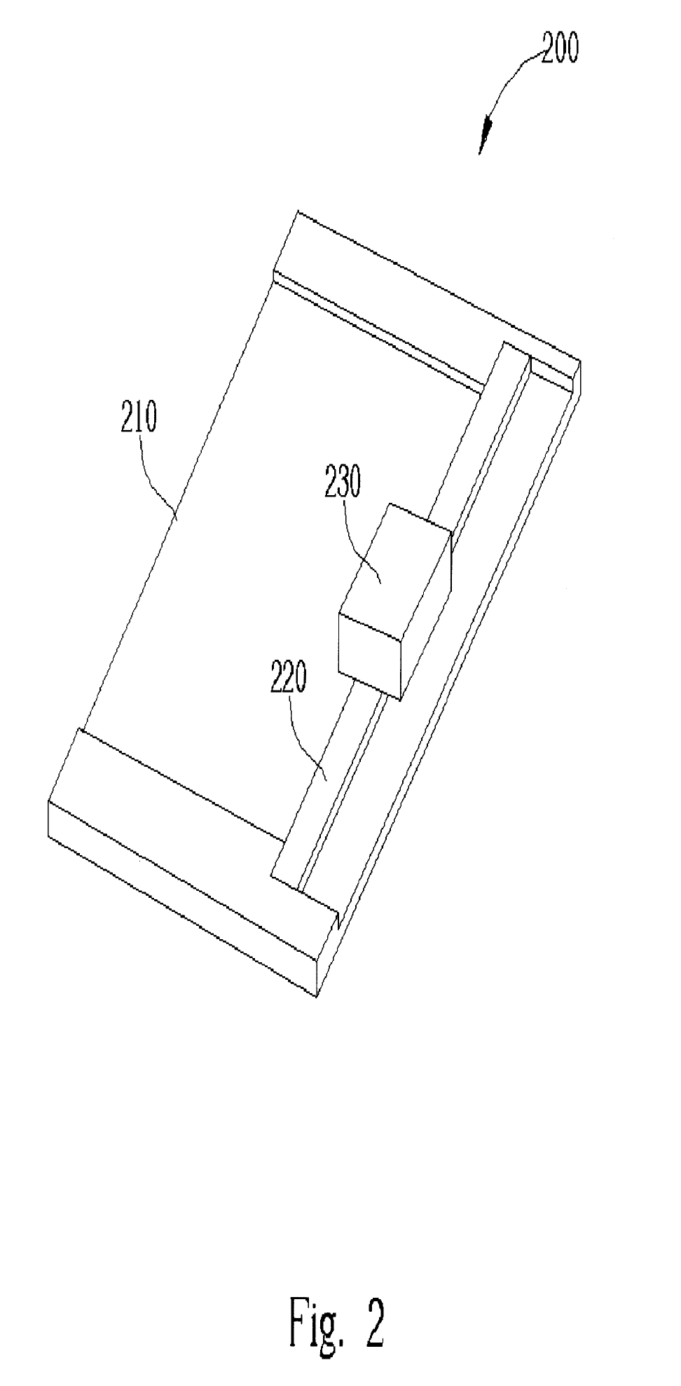

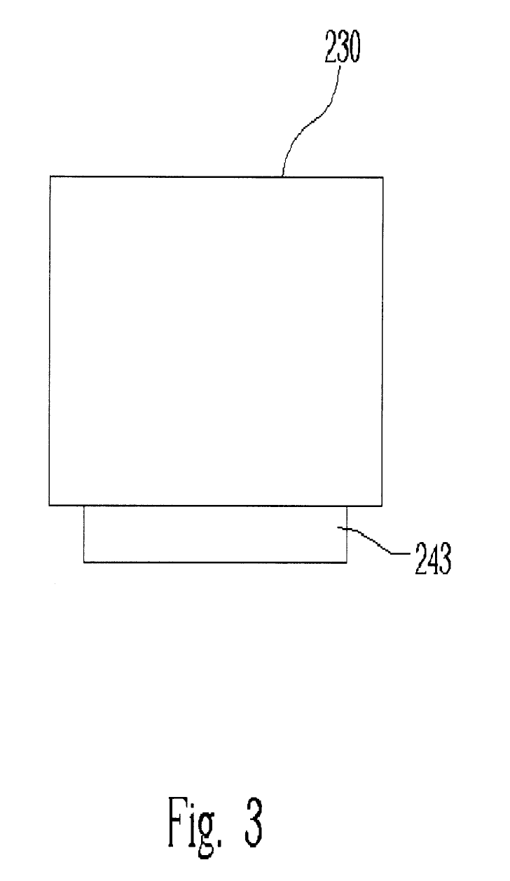

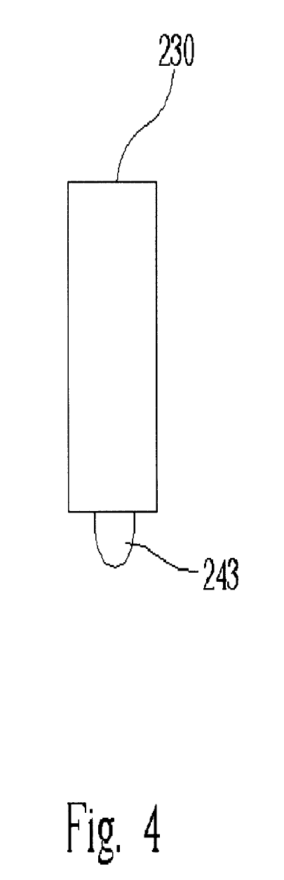

Please refer to FIG. 2. FIG. 2 is a diagram of an apparatus 200 for forming a folding-line on a material according to the present invention. The apparatus 200 comprises a base 210, a rail 220 mounted on the base 210, a carriage 230 slidably mounted on the rail 220, and a blade mounted on the carriage. Please refer to FIG. 3. FIG. 3 is a diagram of the carriage 230 with the blade mounted on the carriage 230 in FIG. 2. The blade 243 is fixed to the carriage 230 and includes an arc-shaped portion for forming the folding-line on the material. Please refer to FIG. 4. FIG. 4 is a side elevation of the carriage 230 and the blade 243 in FIG. 3. When sliding the carriage 230 along the rail 220, the arc-shaped portion of blade 243 slides on the material and forms a folding-line on the material.

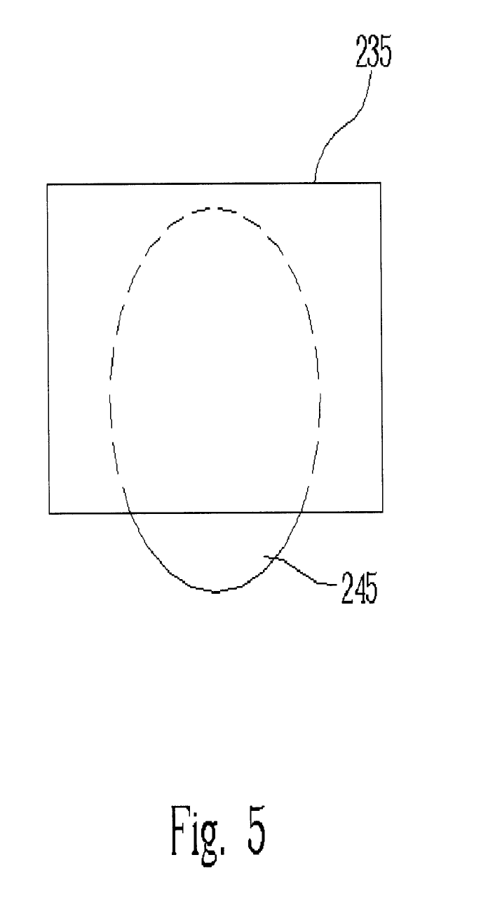

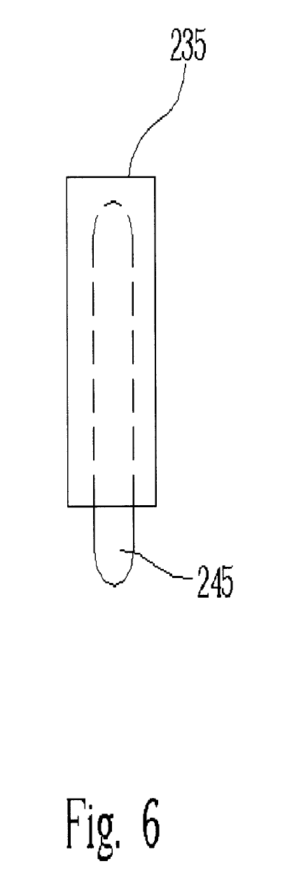

It is able to have the blade rotatably engaged with the carriage. Please refer to FIG. 5. FIG. 5 is a diagram of an embodiment of a carriage and a blade rotatably engaged with the carriage according to the present invention. 235 is a carriage in the claimed apparatus for forming a folding-line on a material. The blade 245 is rotatably engaged with the carriage 235. The blade 245 includes an arc-shaped portion wherein the arc-shaped portion surrounds the blade. Please also refer to FIG. 6. FIG. 6 is a side elevation of the carriage 235 and the blade 245 in FIG. 5.When sliding the carriage 235 along the rail of the claimed apparatus, the blade 245 rotates on the material along with the carriage 235, and the arc-shaped portion of the blade 245 touches the material on the base and forms a folding-line on the material.

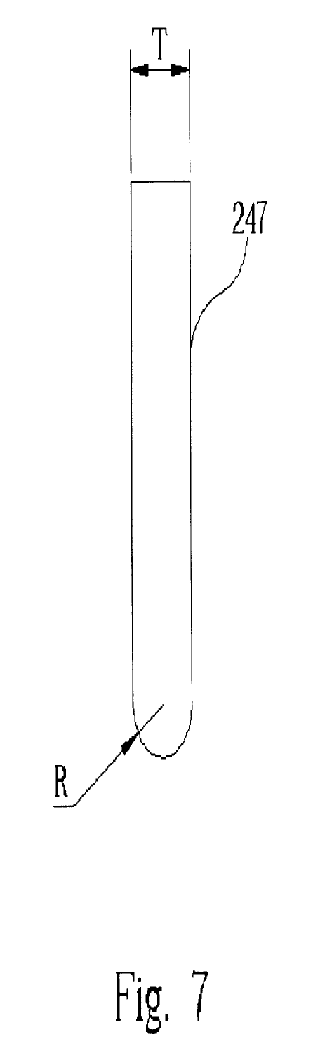

The present invention adapts a blade including an arc-shaped portion to forming a folding-line on a material. When the blade slides or rotates on the material, it is the arc-portion that contacts the material and forms a folding-line on the material. The radius of the arc-shaped portion is designed appropriately so that the material is not cut apart by the blade. Please refer to FIG. 7. FIG. 7 is a side elevation of a blade 247 according to the present invention. The blade 247 is designed fixed to the carriage and slides on the material along with the carriage. R is the radius of the arc-portion of the blade 247, and T is the thickness of the blade 247. R is half of T so that the blade 247 does not cut off the material when the blade 247 slides on the material. When the blade is designed fixed to the carriage and sliding on the material along with the carriage, a guiding slit on the base along the rail helps to avoid the squeeze of the material caused by the blade.

In contrast to the prior art, the operation of the present invention apparatus for forming a folding-line on material is easier and hence more appropriate for office application.

Those skilled in the art will readily observe that numerous modifications and alterations of the device may be made while retaining the teachings of the invention. Accordingly, the above disclosure should be construed as limited only by the metes and bounds of the appended claims.

1. An apparatus for forming a folding-line on a material comprising:
a base for placing the material;
a rail mounted on the base;
a carriage slidably mounted on the rail; and
a blade mounted on the carriage, the blade including an arc-shaped portion for forming the folding-line on the material.

2. The apparatus of claim 1 wherein the arc-shaped portion surrounds the blade.

3. The apparatus of claim 1 wherein the blade is rotatable coupled to the carriage.

4. The apparatus of claim 1 wherein the blade is fixed to the carriage.

5. The apparatus of claim 4 wherein the base comprises a guiding slit along the rail.

6. The apparatus of claim 1 wherein a radius of the arc-shaped portion is half of a thickness of the blade.

7. The apparatus of claim 1 wherein the material is paper.
